(19) United States
(12) Patent Application Publication
(10) Pub. No.: US 2006/0208177 A1
(43) Pub. Date: Sep. 21, 2006

(54) Device to prevent diffused reflection and light scanning unit having the same

(76) Inventor: Jung-hyuck Cho, Seoul (KR)

Correspondence Address: STANZIONE & KIM, LLP, 919 18TH STREET, N.W., SUITE 440, WASHINGTON, DC, 20006, US

(21) Appl. No.: 11/359,584

(22) Filed: Feb. 23, 2006

(30) Foreign Application Priority Data
Mar. 17, 2005 (KR) 10-2005-0022190

(51) Int. Cl. H01J 3/14; H01J 5/16

(52) U.S. Cl. 250/234; 250/216

(57) ABSTRACT

A device to prevent diffused reflection of light in a light scanning unit includes a light source to generate and irradiate light, a housing in which the light source is installed and which has an opening through which the light irradiated by the light source passes, a collimator lens separated from the light source by a predetermined distance and condensing the light that has passed through the opening, and a holder in which the collimator lens is installed, and where an uneven portion is formed on an inner surface of the opening or the holder to prevent the diffused reflection of the light. Light is prevented from being diffusely reflected from the inner surface of the opening or the holder such that the quality of an image being formed is not degraded by diffused reflection.

### CROSS-REFERENCE TO RELATED APPLICATIONS

This application claims the benefit of Korean Patent Application No. 10-2005-0022190, filed on Mar. 17, 2005 in the Korean Intellectual Property Office, the entire disclosure of which is incorporated herein by reference.

### BACKGROUND OF THE INVENTION

1. Field of the Invention

The present general inventive concept relates to a light scanning unit, and more particularly, to a device to prevent diffused reflection of light irradiated by a light source and a light scanning unit having the same.

2. Description of the Related Art

In general, a light scanning unit, such as a laser scanning unit (LSU), is used in devices such as laser printers, digital copying machines, facsimiles, or bar code readers, and forms a latent image on a photosensitive body by performing a main scanning operation using a beam deflector and a subsidiary scanning operation to rotate the photosensitive body. In such a light scanning unit, light irradiated by a light source passes through a predetermined path so that an electrostatic latent image is formed on an object, such as the photosensitive body, to be exposed to the light.

FIG. 1 illustrates a portion of an optical system of a conventional light scanning unit. Referring to FIG. 1, the light scanning unit includes optical elements, such as a light source 1 for generating and irradiating light L and a collimator lens 2 for condensing and collimating the light L irradiated by the light source 1. The light source 1 is inserted in a housing 5 with an opening 10 through which the light L irradiated by the light source 1 passes. In addition, the collimator lens 2 is installed inside a holder 50 that separates the collimator lens 2 from the housing 5 by a predetermined distance.

In general, the light L irradiated by the light source 1 is diffused while traveling along a predetermined path. However, a portion of the diffused light L that is not used to form an image or light L1 and L2 reflected from an inner surface of the opening 10 or the holder 50, may be incident on the collimator lens 2 to form an image on a surface of the object that is to be exposed via a predetermined path of the light. If the light L1 and L2 diffused in this way are incident on the image-forming surface of the object to be exposed, the quality of the image is degraded.

As described above in the prior art, the light L irradiated by the light source 1 that is not intended to be used to form the image or the light L1 and L2 reflected from the inner surface of the opening 10 of the holder 50 may have a negative impact on the image-forming process and thereby degrade the quality of the image.

### SUMMARY OF THE INVENTION

The present general inventive concept provides a device to prevent diffused reflection that affects the quality of an image, and a light scanning unit having the same.

Additional aspects and advantages of the present general inventive concept will be set forth in part in the description which follows and, in part, will be obvious from the description, or may be learned by practice of the general inventive concept.

The foregoing and/or other aspects of the present general inventive concept may be achieved by providing a device to prevent diffused reflection of light in a scanning unit, the device including a light source to generate and irradiate light, a housing in which the light source is installed and which has an inner surface to define an opening through which the light irradiated by the light source passes, a collimator lens separated from the light source by a predetermined distance, and to condense the light that has passed through the opening, and a holder in which the collimator lens is installed, where an uneven portion is formed on an inner surface of the housing to prevent diffused reflection of the light irradiated by the light source.

The inner surface of the housing may include an inclined surface inclined inwardly with respect to a direction where the light passes, and the uneven portion may be formed on the inclined surface.

A inner diameter of the inclined surface may decrease as the inclined surface is more distant from the light source.

An inner diameter of the inclined surface may increase as the inclined surface is more distant from the light source.

The holder may include a second inclined surface inclined inwardly or outwardly with respect to the direction where the light passes and formed on an inner surface of the holder between an end of the holder on which the light is incident and the collimator lens, and the uneven portion may be formed on the second inclined surface formed on the inner surface of the holder.

An inner diameter of the inclined surface formed on the inner surface of the holder may decrease as the inclined surface is more distant from the light source.

An inner diameter of the inclined surface formed at the inner surface of the holder may increase as the inclined surface is more distant from the light source.

The foregoing and/or other aspects of the present general inventive concept may also be achieved by providing a device to prevent diffused reflection of light in a scanning unit, the device including a light source to generate and irradiate light, a housing in which the light source is installed and which has an opening through which the light irradiated by the light source passes, a collimator lens separated from the light source by a predetermined distance and collimating the light that has passed through the opening, and a holder in which the collimator lens is installed, where an uneven portion is formed on an inner surface of the holder between an end of the holder on which the light is incident and the collimator lens to prevent diffused reflection of the light irradiated by the light source.

The inner surface of the holder comprises an inclined surface inclined inwardly or outwardly with respect to a direction where the light passes between an end of the holder on which the light is incident and the collimator lens, and the uneven portion may be formed on the inclined surface formed on the inner surface of the holder.

An inner diameter of the inclined surface formed on the inner surface of the holder may decrease as the inclined surface is more distant from the light source.

An inner diameter of the inclined surface formed on the inner surface of the holder may increase as the inclined surface is more distant from the light source.

The foregoing and/or other aspects of the present general inventive concept may also be achieved by providing a light scanning unit having a device to prevent diffused reflection which prevents diffused reflection of light irradiated by a light source, the light scanning unit including a light source to generate and irradiate light, a housing in which the light source is installed and which has an inner surface to define an opening through which the light irradiated by the light source passes, a collimator lens separated from the light source by a predetermined distance, and to collimate the light that has passed through the opening, and a holder in which the collimator lens is installed, wherein an uneven portion is formed on the inner surface of the opening to prevent diffused reflection of the light irradiated by the light source.

The inner surface may include an inclined surface inclined inwardly or outwardly with respect to a direction where the light passes, and the uneven portion may be formed on the inclined surface.

The holder may include a second inclined surface inclined inwardly or outwardly with respect to a direction where the light passes and formed on a second inner surface of the holder between an end of the holder on which the light is incident and the collimator lens, and the uneven portion may be formed on the second inclined surface formed on the second inner surface of the holder.

The holder may include a second uneven portion that prevents diffused reflection of the light irradiated by the light source and formed on an inner surface of the holder between an end of the holder on which the light is incident and the collimator lens.

The holder may include a second inclined surface inclined inwardly or outwardly with respect to a direction where the light passes and formed on a second inner surface of the holder between an end of the holder on which the light is incident and the collimator lens, and the uneven portion may be formed at the second inclined surface formed on the second inner surface of the holder.

The inner surface of the housing may be substantially parallel with respect to a an optical axis along which the light passes from the light source to the collimator lens.

The foregoing and/or other aspects of the present general inventive concept may also be achieved by providing a device to prevent diffused reflection of light in an image forming device, the device including a light source to irradiate light, a housing having an inside surface to define an opening through which the light irradiated from the light source passes, a holder having a second inside surface to define a second opening, and a collimator lens that receives the light irradiated from the light source through the opening and the second opening, and an uneven portion formed on at least one of the inside surface of the housing and the second inside surface of the holder to prevent diffused reflection of the light irradiated from the light source.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 illustrates a portion of an optical system of a conventional light scanning unit;

FIG. 2 illustrates an optical system of a light scanning unit according to an embodiment of the present general inventive concept;

FIG. 3 illustrates a device to prevent diffused reflection according to an embodiment of the present general inventive concept;

FIG. 4 illustrates a device to prevent diffused reflection according to an embodiment of the present general inventive concept;

FIG. 5 illustrates a device to prevent diffused reflection according to an embodiment of the present general inventive concept;

FIG. 6 illustrates a device to prevent diffused reflection according to an embodiment of the present general inventive concept; and

FIG. 7 illustrates a device to prevent diffused reflection according to an embodiment of the present general inventive concept.

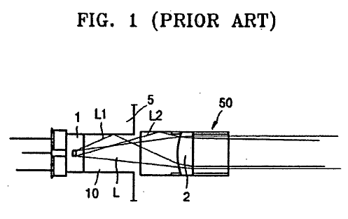

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

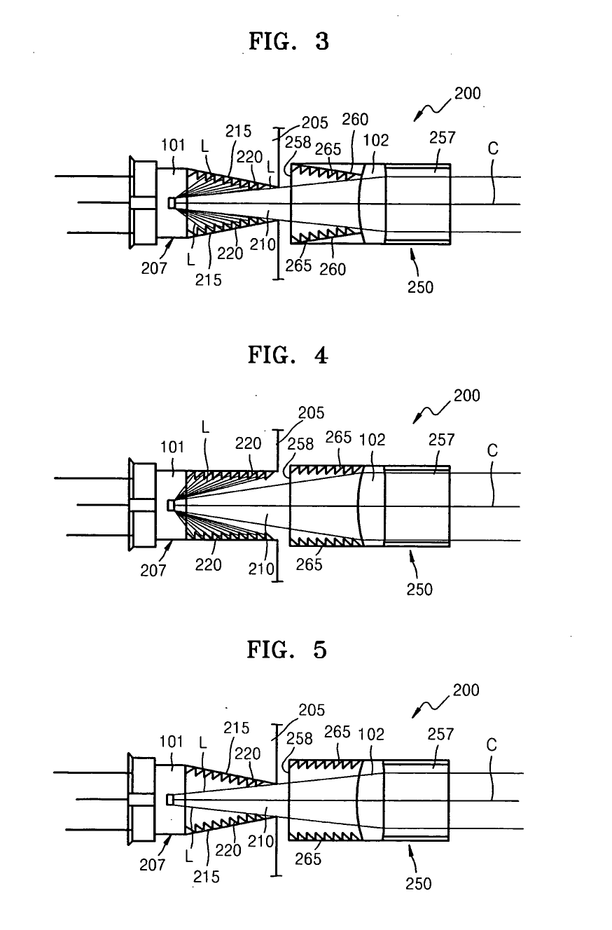

A device to prevent diffused reflection and a light scanning unit having the same according to the present general inventive concept may be used in devices such as digital copying machines, electrophotographic image forming apparatuses, facsimiles, or bar code readers. The configuration and operation of the present general inventive concept will now be described by exemplifying the device to prevent diffused reflection included in a laser scanning unit which is the light scanning unit usable with an electrophotographic image forming apparatus. However, the device to prevent diffused reflection should not be limited thereto, and may be included with other types of apparatuses that use diffusion reflection prevention. In addition, for the convenience of explanation, like elements having like reference numerals described with reference to FIGS. 3 through 7 refer to like elements throughout.

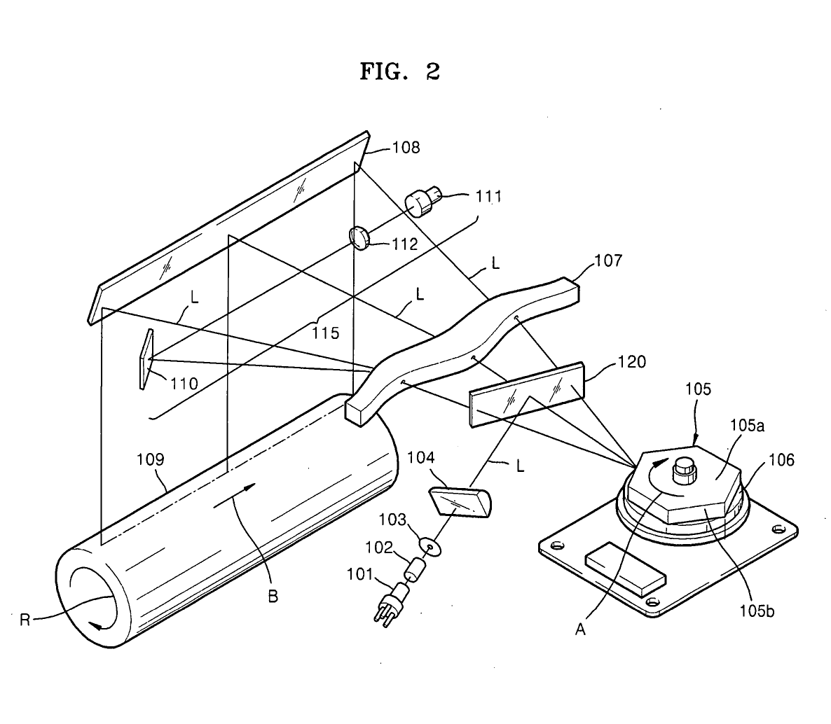

FIG. 2 illustrates an optical system of a light scanning unit according to an embodiment of the present general inventive concept. Referring to FIG. 2, the light scanning unit scans light L onto a photosensitive body 109 that pivots in a predetermined direction. The light scanning unit includes a light source 101, a collimator lens 102, a slit 103, a cylinder lens 104, a beam splitter 120, a beam deflector 105, a driving source 106, an f-θ lens 107, an image-forming mirror 108, and a synchronous signal detector 115.

The light source 101 is on/off controlled by a driving circuit (not shown) and generates and irradiates at least the light L that corresponds to an image signal. That is, the light source 101 is on/off controlled by the driving circuit so that the light L is irradiated onto a portion of an object, such as the photosensitive body, to be exposed to form an electrostatic latent image, and generates and scans the object with the light L that corresponds to the image signal. The light source 101 irradiates the light L in a single light or multi-light format. When the light source 101 is used in a structure that forms, for example, one scanning line, the light source 101 generates and scans single light. On the other hand, when the light source 101 is used in a light scanning unit that scans multi-light, the light source 101 is formed in a light source module and generates and irradiates light that is independently optically modulated. The light source 101 may include an edge emitting diode, a vertical cavity surface emitting laser (VCSEL), or a light emitting device (LED). Here, the configuration and operation of the light source 101 are widely known in the art, and thus any further description thereof will be omitted.

The collimator lens 102 is separate from the light source 101, and condenses and collimates the light L irradiated by the light source 101. The slit 103 is attached to an end of the collimator lens 102 and restricts the light L that passes through the collimator lens 102. The cylinder lens 104 forms a linear image on the beam deflector 105 using the light L that has passed through the slit 103.

The beam splitter 120 is disposed between the beam deflector 105 and the f-θ lens 107 on the same horizontal plane as the beam deflector 105 and the f-θ lens 107. The beam splitter 120 transmits a portion of the light L that has passed through the cylinder lens 104 and reflects a portion of the light L that reflects off a surface of the beam splitter 120. A half mirror that transmits, for example, 50% of incident light L, may be used as the beam splitter 120.

The beam deflector 105 deflects the light L reflected from the beam splitter 120 in a horizontal direction at the same linear velocity to scan the light L. A path of the light L incident on the beam deflector 105 is approximately opposite to a light reflection path of the light L deflected from the beam deflector 105. If the beam deflector 105 is rotated in a direction indicated by the arrow “A” in FIG. 2, the light L is scanned in a direction of arrow “B” (i.e., a main scanning direction) and image information is recorded onto a surface of the photosensitive body 109. The beam deflector 105 may be a polygon mirror device that includes a driving source 106 that rotates a polygon mirror 105a at a predetermined velocity. The polygon mirror 105a is installed to be rotated around the driving source 106. The polygon mirror 105a includes a plurality of reflective surfaces 105b formed at sides of the polygon mirror 105a. Here, the beam deflector 105 is not limited to the polygon mirror device having the above structure, and a hologram disc type beam deflector that deflects and scans incident light or a galvanometer type scanning device can also be used as the beam deflector 105.

The f-θ lens 107 is disposed on an optical path between the beam deflector 105 and the image-forming mirror 108. The f-θ lens 107 includes at least one lens to correct the light deflected by the beam deflector 105 with different magnifications in a main scanning direction (direction of arrow “B”) and in a subsidiary scanning direction, respectively, so as to form an image on the photosensitive body 109. Here, the subsidiary scanning direction is a rotational direction of the photosensitive body 109 (direction of arrow “R”), and the main scanning direction is an axial direction (direction of arrow “B”) of the photosensitive body 108, that is, a direction where the light L is deflected by the beam deflector 105, as illustrated in FIG. 2. The f-θ lens 107 may be plastic injection molded so as to improve productivity and reduce costs.

The image-forming mirror 108 reflects the light L that has passed through the f-θ lens 107 and forms an image on an exposed surface of the photosensitive body 109 which is an image-forming surface. The image-forming mirror 108 may be inclined so that a scanning line directed to the exposed surface of the photosensitive body 109 is perpendicular to the subsidiary scanning direction, i.e., the transfer direction of the photosensitive body 109.

The synchronous signal detector 115 forms horizontal synchronization of scanned light by receiving a portion of the light L irradiated by the light source 101. To this end, the synchronous signal detector 115 includes a synchronous signal detecting sensor 111, a reflection mirror 110, and a condenser lens 112. The synchronous signal detecting sensor 111 receives a portion of the light L deflected by the beam deflector 105 and that has passed through the f-θ lens 107. The reflection mirror 110 is disposed between the f-θ lens 107 and the synchronous signal detecting sensor 111 and changes a traveling path of incident light, and the condenser lens 112 condenses the light L reflected from the reflection mirror 110.

The light scanning unit of the optical system described above with regard to FIG. 2 may further include a device to prevent diffused reflection so as to prevent the quality of an image from being degraded by diffused reflection of the light L irradiated by the light source 101. The device to prevent diffused reflection will now be described in detail with reference to FIGS. 3-7.

FIG. 3 illustrates a device 200 to prevent diffused reflection according to an embodiment of the present general inventive concept. Referring to FIGS. 2 and 3, the device 200 to prevent diffused reflection includes the light source 101 that generates and irradiates light L, a housing 205 in which the light source 101 is installed, the collimator lens 102 separated from the light source 101 by a predetermined distance, and a holder 250 in which the collimator lens 102 is installed. The light source 101, the housing 205, the holder 250, and the collimator lens 102 are disposed along or around an optical axis C.

The light source 101 is on/off controlled by a driving circuit (not shown) and generates and irradiates the light L that corresponds to the image signal. The light L irradiated by the light source 101 is incident on the collimator lens 102 via an opening 210 in the housing 205. The light source 101 is inserted in the housing 205.

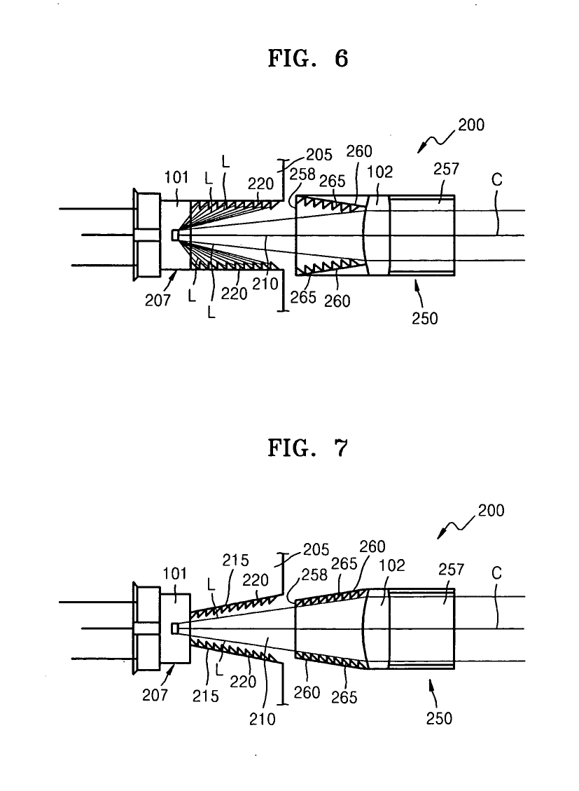

A through hole 207 is formed in the housing 205 to allow light irradiated from the light source 101 to pass through. The light source 101 is inserted in one side of the through hole 207 such that the opening 210 through which the light irradiated by the light source 101 passes is disposed at the other side of the through hole 207. The through hole 207 may be formed in a cylindrical shape to be approximately parallel to a traveling direction of the light L (see FIGS. 4 and 6) and may also be formed at an inclined angle with respect to the optical axis C (see FIGS. 3, 5, and 7). In addition to the through hole 207 being parallel or at an inclined angle, the through hole 207 may be formed, for example, in a circular shape. An uneven portion 220 that prevents diffused reflection of the light L irradiated by the light source 101 is formed on an inner surface defining the opening 210, that is, on an inner surface of the through hole 207. A portion of the light L of the light irradiated by the light source 101 that is not used to form an image and/or diffusely reflected light of the light L is reflected in a predetermined direction by the uneven portion 220 that protrudes from the surface defining the opening 210, and is thus extinguished. The uneven portion 220 may be a triangular shaped uneven portion as illustrated in FIGS. 3-7 or, alternatively, a rectangular or thread-shaped uneven portion. The uneven portion 220 protrudes toward the optical axis C by a distance. The distance of the uneven portion may vary according to a distance from the light source 101.

Referring to FIG. 3, an inclined surface 215 is inclined inwardly with respect to a direction that the light L passes and is disposed on an inner surface of the opening 210. The uneven portion 220 may be formed on the inclined surface 215. The inner diameter of the inclined surface 215 may decrease as the inclined surface 215 is more distant from the light source 101, as illustrated in FIGS. 3 and 5, or the inner diameter of the inclined surface 215 may increase as the inclined surface 215 is more distant from the light source 101, as illustrated in FIG. 7. Alternatively, the uneven portion 220 may be formed on the inner surface of the opening 210 to be approximately parallel to the traveling direction of the light L, as illustrated in FIGS. 4 and 6. In addition, the opening 210 may be formed in a cylinder or circular shape.

On the inclined surface 215 whose inner diameter decreases as it is more distant from the light source 101 (FIGS. 3 and 5), the light L is reflected by the uneven portion 220 and extinguished to keep the reflected light from passing through the opening 210 toward the collimator lens 102 or irradiated outside the opening 210 at a diffusion angle different from that of effective light used to form the image, so that the radiated light is not transmitted toward the collimator lens 102. Alternatively, on the inclined surface 215 whose inner diameter increases as it is more distant from the light source 101 (FIG. 7), the light is reflected by the uneven portion 220 and extinguished to keep the reflected light from passing through the opening 210 or irradiated outside the opening 210 at a larger diffusion angle than that of the effective light used to form the image. That is, the uneven portion 220 is formed on the inner surface of the opening 210 such that the quality of the image being formed is not degraded by diffused reflection of a portion of the light that is not intended to be used to form the image.

The collimator lens 102 separated from the light source 101 by the predetermined distance, condenses and collimates the light L that is irradiated by the light source 101 and has passed through the opening 210. The collimator lens 102 is inserted in the holder 250.

A second through hole 257 through which the collimator lens 102 is inserted into the holder 250 is formed in the holder 250. A second uneven portion 265 that prevents diffused reflection of the light L irradiated by the light source 101 is formed on an inner surface of the holder 250 between an end 258 on which the light is incident and the collimator lens 102. The light L that has passed through the opening 210 but is not intended to be used to form the image and/or diffusely reflected light L are reflected by the second uneven portion 265 that protrudes from the inner surface of the holder 250 in a predetermined direction, and are then extinguished. The second uneven portion 265 may be a triangular shaped uneven portion as illustrated in FIGS. 3-7 or a rectangular uneven portion, as illustrated in FIG. 3. Alternatively, the uneven portion 265 may be a thread-shaped uneven portion.

In FIGS. 3 and 6, a second inclined surface 260 is inclined inwardly with respect to a direction that the light L passes and is formed on the inner surface of the holder 250 between the end 258 on which the light is incident and the collimator lens 102. The second uneven portion 265 may be formed on the inclined surface 260. The inner diameter of the inclined surface 260 may decrease as the inclined surface 215 is more distant from the light source 101, as illustrated in FIGS. 3 and 6. Alternatively, the inner diameter of the inclined surface 215 may increase as the second inclined surface 260 is more distant from the light source 101, as illustrated in FIG. 7. In addition, the second inclined surface 260 may be inclined outwardly with respect to the direction that the light L passes through an inner surface of the holder 250 between the end 258 on which the light is incident and the collimator lens 102, as illustrated in FIG. 7. Alternatively, the uneven portion 265 may be formed on the inner surface of the opening 250 to be approximately parallel to the traveling direction of the light L, as illustrated in FIGS. 4 and 5. In addition, the opening 250 may be formed in a cylinder or circular shape.

On the second inclined surface 260 whose inner diameter decreases as it is more distant from the light source 101 (FIGS. 3 and 6), the light L is reflected by the second uneven portion 265 in a direction opposite to a traveling direction of the light L or is reflected by the second uneven portion 265 and extinguished so that it is not incident on the collimator lens 102. Alternatively, on the second inclined surface 260 whose inner diameter increases as it is more distant from the light source 101 (FIG. 7), only effective light used to form an image is incident on the collimator lens 102. As described above, the second uneven portion 265 is formed on the inner surface of the holder 250. In addition, the second inclined surface 260 may be formed on the inner surface of the holder 250 between the end 258 on which the light L is incident and the collimator lens 102 such that the quality of the image being formed is not degraded by diffused reflection of a portion of the light L that is not intended to be used to form the image.

FIGS. 4 through 7 illustrate the device 200 to prevent diffused reflection according to embodiments of the present general inventive concept. Referring to FIGS. 4 through 6, the inclined surface 215 or the second inclined surface 260 is formed on the inner surface of the opening 210 or on the inner surface of the holder 250 between the end 258 on which the light L is incident and the collimator lens 102. The uneven portion 220 or the second uneven portion 265 is formed on the inclined surface 215 or the second inclined surface 260 such that the quality of the image being formed is not degraded by diffused reflection of the portion of the light L that is not intended to be used to form the image. Alternatively, the uneven portion 220 or the second uneven portion 265 may be formed on the inner surface of the opening 210 or on the inner surface of the holder 250 to be parallel to the traveling direction of the light L. At least one of the uneven portion 220 and the second uneven portion 265 may be formed in the device to control diffused reflection of light.

The entire configuration and operation of the device 200 to prevent diffused reflection illustrated in FIGS. 4 through 7 are similar to those of the device 200 to prevent diffused reflection illustrated in FIG. 3, and thus any further description thereof will be omitted. In addition to the embodiments described with reference to FIGS. 4 through 7, although not shown, the device 200 may include an inner diameter of a first one of the inclined surface 215 formed on the inner surface of the opening 210 and the second inclined surface 260 formed on the inner surface of the holder 250 that decreases as the inclined surface 215 or the second inclined surface 260 is more distant from the light source 101 in combination with an inner diameter of a second one of the inclined surface 215 and the second inclined surface 260 that increases as it is more distant from the light source 101 and vice versa. In addition, the inclined surface 215 and/or the second inclined surface 260 may be coated with a material that can prevent diffused reflection of the light L irradiated by the light source 101.

The operation of the device to prevent diffused reflection and the light scanning unit having the same according to the present general inventive concept will now be described with reference to FIGS. 2 and 3.

Referring to FIGS. 2 and 3, the light source 101 is on/off controlled by a driving circuit (not shown) in response to the image signal and generates and irradiates at least some of the light L that corresponds to the image signal. The light L irradiated by the light source 101 is incident on the collimator lens 102 via the opening 210 in the housing 205. In this case, the light L irradiated by the light source 101 travels while being diffused in the traveling direction of the light L. The light L of the diffused light L that is not used to form an image or the light L diffusely reflected from the inner surface of the opening 210 or the holder 250 may be incident on the collimator lens 102 and the image may be formed on the surface of the photosensitive body 109 via a predetermined optical path. As such, the quality of the image is degraded. As illustrated in FIGS. 2 and 3, the inclined surface 215 or the second inclined surface 260 or the uneven portion 220 or the second uneven portion 265 is formed on the inner surface of the opening 210 and/or the holder 250 such that the light L is prevented from being diffusely reflected and incident on the collimator lens 102.

The light that has passed through the collimator 102, the slit 103, and the cylinder lens 104 from the light source 101 is reflected from the beam splitter 120 and incident on a central portion of the f-θ lens 107, and the light that has passed through the f-θ lens 107 is incident on a reflective surface of the beam deflector 105. The light reflected from the reflective surface of the beam deflector 105 passes through the central portion of the f-θ lens 107, an optical path is bent at the image-forming mirror 108, and an image is formed on the surface of the photosensitive body 109. The synchronous signal detecting sensor 111 receives the portion of the light deflected by the beam deflector 105 and that has passed through the f-θ lens 107, and forms horizontal synchronization. The reflection mirror 110 reflects the light toward the synchronous signal detecting sensor 111.

According to the above-described structure, in the present general inventive concept, the inclined surface 215 and/or the second inclined surface 260 and the uneven portion 220 and/or the second uneven portion 265 is formed on the inner surface of the opening 210 and/or the holder 250 such that the light L is prevented from being diffusely reflected and incident on the collimator lens 102. The light scanning unit according to the present general inventive concept is used in devices such as digital copying machines, electrophotographic image forming apparatuses, facsimiles, or code readers, however, the light scanning unit is not limited thereto.

As described above, in the device to prevent diffused reflection and the light scanning unit having the same according to the present general inventive concept, light can be prevented from being diffusely reflected from the inner surface of the opening and/or the holder. Thus, the quality of the image being formed may not be degraded by diffused reflection.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A device to prevent diffused reflection of light in a scanning unit, the device comprising:
a light source to generate and irradiate light;
a housing in which the light source is installed and which has an inner surface to define an opening through which the light irradiated by the light source passes;
a collimator lens separated from the light source by a predetermined distance, and to condense the light that has passed through the opening; and
a holder in which the collimator lens is installed,
wherein an uneven portion is formed on an inner surface of the housing to prevent diffused reflection of the light irradiated by the light source.

2. The device of claim 1, wherein the inner surface of the housing comprises an inclined surface inclined inwardly or outwardly with respect to a direction where the light passes, and the uneven portion is formed on the inclined surface.

3. The device of claim 2, wherein an inner diameter of the inclined surface decreases as the inclined surface is more distant from the light source.

4. The device of claim 2, wherein an inner diameter of the inclined surface increases as the inclined surface is more distant from the light source.

5. The device of claim 2, wherein the holder comprises a second inclined surface inclined inwardly or outwardly with respect to the direction where the light passes and formed on an inner surface of the holder between an end of the holder on which the light is incident and the collimator lens, and the uneven portion is formed on the second inclined surface formed on the inner surface of the holder.

6. The device of claim 5, wherein an inner diameter of the inclined surface formed on the inner surface of the holder decreases as the inclined surface is more distant from the light source.

7. The device of claim 5, wherein an inner diameter of the inclined surface formed at the inner surface of the holder increases as the inclined surface is more distant from the light source.

8. A device to prevent diffused reflection of light in a scanning unit, the device comprising:
a light source to generate and irradiate light;
a housing in which the light source is installed and which has an opening through which the light irradiated by the light source passes;
a collimator lens separated from the light source by a predetermined distance and collimating the light that has passed through the opening; and
a holder in which the collimator lens is installed,
wherein an uneven portion is formed on an inner surface of the holder between an end of the holder on which the light is incident and the collimator lens to prevent diffused reflection of the light irradiated by the light source.

9. The device of claim 8, wherein the inner surface of the holder comprises an inclined surface inclined inwardly or outwardly with respect to a direction where the light passes between an end of the holder on which the light is incident and the collimator lens, and the uneven portion is formed on the inclined surface formed on the inner surface of the holder.

10. The device of claim 9, wherein an inner diameter of the inclined surface formed on the inner surface of the holder decreases as the inclined surface is more distant from the light source.

11. The device of claim 9, wherein an inner diameter of the inclined surface formed on the inner surface of the holder increases as the inclined surface is more distant from the light source.

12. A light scanning unit having a device to prevent diffused reflection which prevents diffused reflection of light irradiated by a light source, the light scanning unit comprising:
a light source to generate and irradiate light;
a housing in which the light source is installed and which has an inner surface to define an opening through which the light irradiated by the light source passes;
a collimator lens separated from the light source by a predetermined distance, and to collimate the light that has passed through the opening; and
a holder in which the collimator lens is installed,
wherein an uneven portion is formed on the inner surface of the opening to prevent diffused reflection of the light irradiated by the light source.

13. The light scanning unit of claim 12, wherein the inner surface comprises an inclined surface inclined inwardly or outwardly with respect to a direction where the light passes, and the uneven portion is formed on the inclined surface.

14. The light scanning unit of claim 13, wherein the holder comprises a second inclined surface inclined inwardly or outwardly with respect to a direction where the light passes and formed on a second inner surface of the holder between an end of the holder on which the light is incident and the collimator lens, and the uneven portion is formed on the second inclined surface formed on the second inner surface of the holder.

15. The light scanning unit of claim 12, wherein the holder comprises a second uneven portion that prevents diffused reflection of the light irradiated by the light source is formed on an inner surface of the holder between an end of the holder on which the light is incident and the collimator lens.

16. The light scanning unit of claim 15, wherein the holder comprises a second inclined surface inclined inwardly or outwardly with respect to a direction where the light passes and formed on a second inner surface of the holder between an end of the holder on which the light is incident and the collimator lens, and the uneven portion is formed at the second inclined surface formed on the second inner surface of the holder.

17. The light scanning unit of claim 12, wherein the inner surface of the housing is substantially parallel with respect to an optical axis along which the light passes from the light source to the collimator lens.

18. A device to prevent diffused reflection of light in an image forming apparatus, the device comprising:
a light source to irradiate light;
a housing having an inside surface to define an opening through which the light irradiated from the light source passes;
a holder having a second inside surface to define a second opening, and a collimator lens that receives the light irradiated from the light source through the opening and the second opening; and
an uneven portion formed on at least one of the inside surface of the housing and the second inside surface of the holder to prevent diffused reflection of the light irradiated from the light source.

19. The device of claim 18, wherein the uneven portion is at least one of triangular, rectangular, or thread shaped.

20. The device of claim 18, wherein at least one of the inside surface of the housing and the second inside surface of the holder is inclined inwardly or outwardly with respect to a direction in which the irradiated light passes.

21. The device of claim 18, wherein the inside surface of the housing and the second inside surface of the holder are both substantially parallel with respect to a direction the irradiated light passes.

22. The device of claim 18, wherein the light comprises a first light radiated from the light source to directly reach the collimator lens, and a second light radiated from the light source to reach the uneven portion such that the second light is prevented from reaching the collimator lens by the uneven portion.
